(19) United States
(12) Patent Application Publication
(10) Pub. No.: US 2016/0169475 A1
(43) Pub. Date: Jun. 16, 2016

(54) User Adjustable LED Lighting Luminaire and Accessories

(71) Applicant: Production Resource Group, LLC, New Windsor, NY (US)

(72) Inventors: Robert Kliegl, Putnam Valley, NH (US); Bruce McFarlane, Wallkill, NY (US); Gary Leonard, Wappingers Fall, NY (US); Barry Carothers, Addison, TX (US); Ted Samuelson, Flower Mound, TX (US); Thomas A. Hough, Dadllas, TX (US); Tom Walsh, Farmers Branch, TX (US); Diane Miller, Grapevine, TX (US)

(21) Appl. No.: 14/944,901

(22) Filed: Nov. 18, 2015

Related U.S. Application Data
(60) Provisional application No. 62/081,643, filed on Nov. 19, 2014.

(51) Int. Cl. F21V 5/00; F21V 13/02; F21V 5/04

(52) U.S. Cl. CPC F21V 5/008; F21V 5/045; F21V 5/04; F21V 13/02; F21Y 2101/02

(57) ABSTRACT

A new LED luminare with movable for now lens, and an aspheric lens to collect light from the LED which is optimized for maximizing light output when the Fresnel lens is furthest from the LED source. For now lens can be moved closer and further to vary between floodlight and spotlight.

This application claims priority from provisional application No. 62/081,643, filed Nov. 19, 2014, the entire contents of which are herewith incorporated by reference.

### BACKGROUND

Incandescent light sources of many types have been known. LEDs can be used to retrofit incandescent fixtures, to obtain better efficiency and less heat. In some lighting fixtures, an LED can simply be inserted into the light fixture in place of the existing light source, e.g., a retrofit bulb. However, in other lighting fixtures, a more complete retrofit may be necessary, in order to address the way that the LED outputs light, and other issues, including the necessity to keep the LEDs cooled.

Our U.S. Pat. No. 8,721,134 describes a retrofit kit for a lamp that uses tungsten light bulbs, and which retrofits that lamp to use LEDs as its light source.

### SUMMARY

An embodiment describes a performance LED fixture with special features, including the ability to control a beam spread from the LED based fixture.

### BRIEF DESCRIPTION OF THE DRAWINGS

in the drawings:

FIGS. 1 a and 1B respectively show the light fixture both packaged by itself and connected to the lighting head;

FIG. 2 illustrates the optical configuration; and

FIG. 3 shows results of how use of an aspherical lens can improve the lighting efficiency.

### DETAILED DESCRIPTION

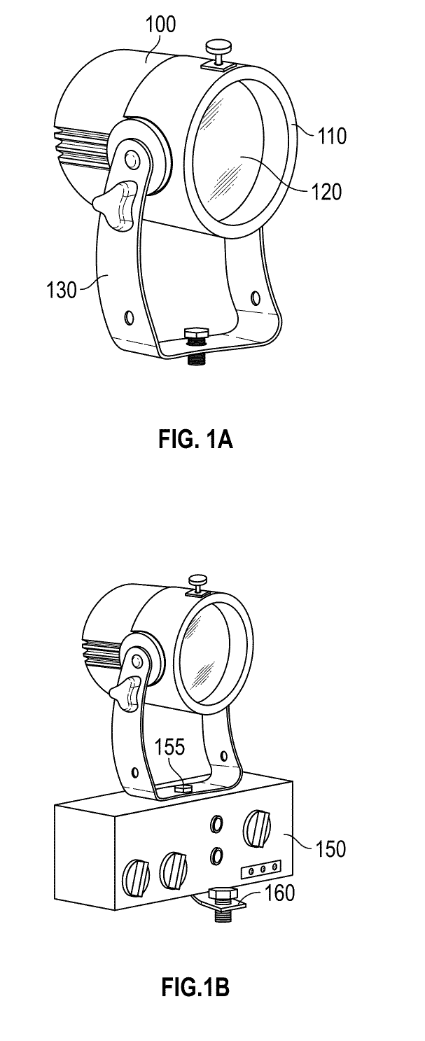

An embodiment shown in FIGS. 1A and 1B illustrate a luminaire according to an embodiment using an LED light source that has a special optical configuration that allows setting the beam angle. The LED sources allow the user to control the beam spread from barrow to wide beam angles by adjusting a unique lens and barrel system.

Different colored light sources can be used within the Luminaire. Different sources include an ultraviolet source (365 nm); a white light source (2700 Kelvin-6500 Kelvin), or a day light source. The light source that is used is formed of an LED light engine that is set inside a housing 100. The housing 100 has a user adjustable front end (barrel) 110 which holds an adjustable plastic or glass Fresnel lens. The adjustments are made manually without the use of tools by the user.

In this embodiment, the Fresnel lens is set closer to the LED array to collect the light from the engine's initial distribution and disperse that light to form a wide and uniform beam of light or floodlight. When the Fresnel lens is adjusted to be further from the LED engine, the light is collected to achieve a tight uniform beam or spotlight.

A secondary diffuser lens or holographic lens can optionally be used to further blend the beams of light as required as to not image the LED engine's structure.

LED drivers are used for direct power and dimming via, 0-10 v, ELV, Triac and Quartz SCR dimmers.

Electronic control can also be used to provide control such as fading, strobe and manual dimming via preprogrammed setting set by the use of dip switches or a push button display screen. Control can alternatively be achieved by the use of the DMX-512 data control protocol. Control signals are brought to the fixture from an appropriate DMX controller via RJ45/CAT5 control cable or 5-PIN XLR cable and connections. The driver assembly has two ports; a first for receiving the data control signal and a second for user preference for passing the signal along to a neighboring fixture, via daisy chaining.

The main lighting assembly of the Bullet Series or lighting Head houses the light engine/array and the lens or lenses for creating the desired beams. The power and/or control assembly is held within Driver box 150. The driver box can also be held on to the head to form a single unit having a unified Head and the Driver Box assembly via hardware for unified mounting of the two assemblies. If the user so desires, the Head can be removed from the Driver box and be remotely mounted from each other. A Head to Driver Box cable is supplied with the assembly and allows the user the standard distance of 3′ separation between the two assemblies however custom lengths of longer or shorter increments can be offered via 4-Pin XLR or other types of connectors and cable.

The head assembly is designed to allow the user to attach optional accessories such as linear spread lenses to create adjustable linear beam angles as opposed to the standard round beam shapes. Another accessory is an ellipsoidal zoom focus (20-50D) lens system for precise focusing of the Bullet Series™ narrow beam. The lens system allows for using the focused beam sizes alone or with optional steel, glass or 35 MM film slides for projecting images, text or textures.

Glass (Dichroic/Devon Glass) of plastic (gel) colored diffusions can also be used with the white light version of the Bullet for tinting the beam of light to user defined colors.

Other accessories include 4 leaf barndoors for soft cropping of the bean and a cylindrical hood (snoot) for blacking light from the sides and reducing visibility while in use in architectural, theatrical or theme park application.

The Bullet Series can be powered via track lighting systems, cord and plug and hardwired applications such as to a junction box (canopy mount).

In one embodiment, the power supply is an external power supply 150 shown in FIG. 1. The light can be mounted on the external power supply, via a nut 155 that connects from the arms 130 of the light into a corresponding mounting part on the power supply. The power supply 150 can be usable for both one or multiple different lights. The power supply itself also includes a mounting part 160 which enables the power supply to be mounted to the same mounting mechanism to which the light would be mounted directly.

The Illumination System uses the Fresnel lens discussed above, e.g. a 6″ fresnel that produces a soft edged beam which varies in diameter from 4.2 feet to 21 feet at a throw distance of 15 feet.

The system is preferably used with an LED light source, but can alternatively be used with a long life, high intensity tungsten halogen lamp.

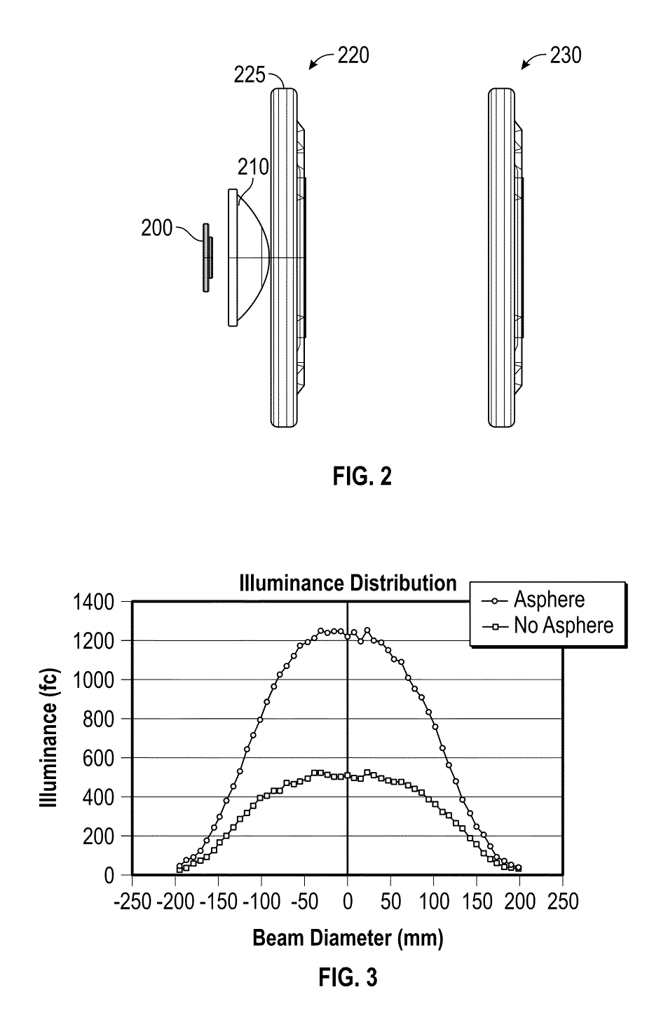

FIG. 2 shows the optical configuration of the White Light Bullet Fresnel system employing a chip on board (COB) LED light source array which is focused by an aspheric lens 210. A moveable Fresnel lens 220 is shown in its two extreme positions 225 and 230. The light source remains stationary and the Fresnel lens is translated along the optical axis to control the size of the projected beam. Like the traditional Fresnel system, the optical system is less efficient in the NFOV when the Fresnel lens is far from the light source. A stationary aspheric lens positioned directly in front of the COB LED light source is used to increase the efficiency in the NFOV. The shape of the lens 210 is designed to maximize the amount of light incident on the Fresnel lens in the NFOV, while simultaneously shaping the beam in the MFOV (and WFOV positions in between the NFOV and MFOV). The resulting design increases the efficiency in the NFOV by greater than 2×. The corresponding NFOV illuminance distributions are shown in FIG. 3.

What is claimed is:

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, other kinds of formats of lights can use the techniques disclosed in this application.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The web site can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A Luminaire Assembly comprising:
an LED light source, energized to create light and along an optical train;
an aspheric lens, collecting light from the LED light source, said aspheric lens located along the optical train; and
a Fresnel lens, movable between a WFOV position where it is closest to the aspheric lens and creates a wide and uniform beam of light as an output, and an NFOV position where the Fresnel lens is furthest from the aspheric lens and creates the light is collected to achieve a tight uniform beam, wherein the aspheric lens is formed to maximize the amount of light for the Fresnel lens when the Fresnel lens is furthest from the aspheric lens.

2. The luminaire assembly as in claim 1, wherein the aspheric lens is fixed in position relative to the LED light source.

3. The luminaire assembly as in claim 1, wherein the LED light source is a chip on board light source.

4. The luminaire assembly as in claim 1, further comprising a diffuser lens along the optical path to prevent imaging the LED light source.

5. The LED luminaire assembly as in claim 1, further comprising a holographic lens along the optical path to prevent imaging the LED light source.

6. The luminaire assembly as in claim 1, wherein the assembly includes a head holding the LED light source and aspheric lens and Fresnel lens, and a controller box, that is separate from the head and where the head is attachable to the controller box.
